(19) United States
(12) Patent Application Publication
(10) Pub. No.: US 2012/0218248 A1
(43) Pub. Date: Aug. 30, 2012

(54) LIQUID CRYSTAL DISPLAY DEVICE

(75) Inventor: Toshihide Tsubata, Osaka-shi (JP)

(73) Assignee: SHARP KABUSHIKI KAISHA, Osaka-shi, Osaka (JP)

(21) Appl. No.: 13/505,465

(22) PCT Filed: Nov. 4, 2010
(86) PCT No.: PCT/JP2010/069620

§ 371 Date: May 2, 2012

(30) Foreign Application Priority Data
Nov. 6, 2009 (JP) 2009-255259

(51) Int. Cl. G09G 5/00; G09G 3/36

(52) U.S. Cl. 345/211; 345/87

(57) ABSTRACT

The liquid crystal display device (100) of this invention has pixels arranged in columns and rows to form a matrix pattern, and includes an active-matrix substrate (10), a counter substrate (20), a liquid crystal layer (30) and a signal line driver (3). The pixels include m kinds of (where m is an even number and m≧4) pixels that display different colors and that are repeatedly arranged in the same order in the row direction. Grayscale voltages of the same polarity are supplied to two of the signal lines (13) of the active-matrix substrate (10), which are adjacent with one of the m kinds of pixels interposed between them. The active-matrix substrate (10) further includes an additional signal line (13D), which is arranged between the two signal lines (13) to run in the column direction and which is supplied with a grayscale voltage, of which the polarity is opposite to the grayscale voltages supplied to the two signal lines (13). The present invention improves the display quality of a liquid crystal display device, of which each picture element is defined by an even number of pixels.

### TECHNICAL FIELD

The present invention relates to a liquid crystal display device and more particularly relates to a liquid crystal display device that conducts a display operation in colors by using four or more kinds of pixels that display mutually different colors.

### BACKGROUND ART

Liquid crystal display devices are currently used in a variety of applications. In a general liquid crystal display device, one picture element consists of three pixels respectively representing red, green and blue, which are the three primary colors of light, thereby conducting a display operation in colors.

A conventional liquid crystal display device, however, can reproduce colors that fall within only a narrow range (which is usually called a “color reproduction range”), which is a problem. Thus, to broaden the color reproduction range of liquid crystal display devices, a technique for increasing the number of primary colors for use to perform a display operation has recently been proposed.

For example, Patent Document No. 1 discloses a liquid crystal display device 800 in which one picture element P is made up of four pixels that include not only red, green and blue pixels R, G and B representing the colors red, green and blue, respectively, but also a yellow pixel Y representing the color yellow as shown in FIG. 15. That liquid crystal display device 800 performs a display operation in colors by mixing together the four primary colors red, green, blue and yellow that are represented by those four pixels R, G, B and Y.

By performing a display operation using four or more primary colors, the color reproduction range can be broadened compared to a conventional liquid crystal display device that uses only the three primary colors for display purposes. Such a liquid crystal display device that conducts a display operation using four or more primary colors will be referred to herein as a “multi-primary-color liquid crystal display device”. And a liquid crystal display device that conducts a display operation using the three primary colors will be referred to herein as a “three-primary-color liquid crystal display device”.

On the other hand, Patent Document No. 2 discloses a liquid crystal display device 900 in which one picture element P is made up of four pixels that include not only red, green and blue pixels R, G and B but also a white pixel W representing the color white as shown in FIG. 16. As the pixel added is a white pixel W, that liquid crystal display device 900 cannot broaden the color reproduction range but can still increase the display luminance.

However, if one picture element P is made up of an even number of pixels as in the liquid crystal display devices 800 and 900 shown in FIGS. 15 and 16, a so-called “horizontal shadow” phenomenon will arise and debase the display quality when a dot inversion drive operation is carried out. The dot inversion drive is a technique for minimizing the occurrence of a flicker on the display screen and is a driving method in which the polarity of the applied voltage is inverted on a pixel-by-pixel basis.

FIG. 17 shows the polarities of voltages applied to respective pixels when a dot inversion drive operation is carried out on a three-primary-color liquid crystal display device. On the other hand, FIGS. 18 and 19 show the polarities of voltages applied to respective pixels when a dot inversion drive operation is carried out on the liquid crystal display devices 800 and 900, respectively.

In a three-primary-color liquid crystal display device, the polarities of the voltages applied to pixels in the same color invert in the row direction as shown in FIG. 17. For example, in the first, third and fifth rows of pixels shown in FIG. 17, the voltages applied to the red pixels R go positive (+), negative (−) and positive (+) in this order from the left to the right. The voltages applied to the green pixels G go negative (−), positive (+) and negative (−) in this order. And the voltages applied to the blue pixels B go positive (+), negative (−) and positive (+) in this order.

In the liquid crystal display devices 800 and 900, on the other hand, each picture element P is made up of an even number of (i.e., four in this case) pixels. That is why in each and every row of pixels, the voltages applied to pixels in the same color have the same polarity everywhere as shown in FIGS. 18 and 19. For example, in the first, third and fifth rows of pixels shown in FIG. 18, the polarities of the voltages applied to every red pixel R and every yellow pixel Y are positive (+) and those of the voltages applied to every green pixel G and every blue pixel B are negative (−). Meanwhile, in the first, third and fifth rows of pixels shown in FIG. 19, the polarities of the voltages applied to every red pixel R and every blue pixel B are positive (+) and those of the voltages applied to every green pixel G and every white pixel W are negative (−).

If the voltages applied to pixels in the same color come to have the same polarity anywhere in the row direction in this manner, a horizontal shadow will be cast when a window pattern is displayed in a single color. Hereinafter, it will be described with reference to FIG. 20 why such a horizontal shadow is cast.

As shown in FIG. 20(a), when a high-luminance window WD is displayed on a low-luminance background BG, horizontal shadows SD, which have a higher luminance than the background to be displayed originally, are sometimes cast on the right- and left-hand sides of the window WD.

FIG. 20(b) illustrates an equivalent circuit of a portion of a normal liquid crystal display device that covers two pixels. As shown in FIG. 20(b), each of these pixels has a thin-film transistor (TFT) 14. A scan line 12, a signal line 13 and a pixel electrode 11 are respectively electrically connected to the gate, source and drain electrodes of the TFT 14.

A liquid crystal capacitor C_{LC} is formed by the pixel electrode 11, a counter electrode 21 that is arranged to face the pixel electrode 11, and a liquid crystal layer that is interposed between the pixel electrode 11 and the counter electrode 21. Meanwhile, a storage capacitor C_{CS} is formed by a storage capacitor electrode 17 that is electrically connected to the pixel electrode 11, a storage capacitor counter electrode 15a that is arranged to face the storage capacitor electrode 17, and a dielectric layer (i.e., an insulating film) interposed between the storage capacitor electrode 17 and the storage capacitor counter electrode 15a.

The storage capacitor counter electrode 15a is electrically connected to a storage capacitor line 15 and supplied with a storage capacitor counter voltage (CS voltage). FIGS. 20(c) and 20(d) show how the CS voltage and the gate voltage change with time. It should be noted that write voltages (i.e., grayscale voltages applied to the pixel electrode 11 through the signal line 13) have mutually different polarities in FIGS. 20(c) and 20(d).

When the gate voltage goes high to start charging a pixel, the potential of the pixel electrode 11 (i.e., its drain voltage) changes. In the meantime, a ripple voltage is superposed on the CS voltage by way of a parasitic capacitance between the drain and the CS as shown in FIGS. 20(c) and 20(d). As can be seen by comparing FIGS. 20(c) and 20(d), the polarity of the ripple voltage inverts according to that of the write voltage.

The ripple voltage superposed on the CS voltage attenuates with time. If the write voltage has small amplitude (i.e., when the write voltage is applied to pixels that display the background BG), the ripple voltage goes substantially zero when the gate voltage goes low. On the other hand, if the write voltage has large amplitude (i.e., when the write voltage is applied to pixels that display the window WD), the ripple voltage becomes relatively high compared to those pixels that display the background BG. As a result, as shown in FIGS. 20(c) and 20(d), even when the gate voltage goes low, the ripple voltage superposed on the CS voltage has not quite attenuated yet. That is to say, even after the gate voltage has gone low, the ripple voltage continues to attenuate. Consequently, due to that residual ripple voltage Vα, the drain voltage (i.e., the pixel electrode potential) affected by the CS voltage varies from its original level.

On the same row of pixels, two ripple voltages of opposite polarities work to cancel each other, but two ripple voltages of the same polarity will superpose one upon the other. That is why if the voltages applied to pixels in the same color come to have the same polarity everywhere in the row direction as shown in FIGS. 18 and 19, horizontal shadows will be cast when a window pattern is displayed in a single color.

Patent Document No. 3 discloses a technique for avoiding casting such horizontal shadows. FIG. 21 illustrates a liquid crystal display device 1000 as disclosed in Patent Document No. 3.

As shown in FIG. 21, the liquid crystal display device 1000 includes an LCD panel 1001, including a number of picture elements P each consisting of red, green, blue and white pixels R, G, B and W, and a source driver 1003 that supplies a display signal to multiple signal lines 1013 of the LCD panel 1001.

The source driver 1003 includes a plurality of individual drivers 1003a, each of which is connected to an associated one of the signal lines 1013. Those individual drivers 1003a are arranged side by side in the row direction and output either a positive or negative grayscale voltage.

In a general source driver, the grayscale voltages output from each and every pair of adjacent individual drivers always have opposite polarities. That is to say, in a horizontal scanning period, the polarities of the grayscale voltages output from the source driver never fail to invert in the row direction in the order of positive, negative, positive, negative and so on.

On the other hand, in the source driver 1003 of the liquid crystal display device 1000, the grayscale voltages output from each pair of adjacent individual drivers 1003a do not always have opposite polarities. That is to say, the polarities of the grayscale voltages output from the source driver 1003 in one horizontal scanning period basically invert in the row direction, but sometimes voltages of the same polarity (i.e., positive and positive voltages or negative and negative voltages) may be output back to back.

Specifically, if those individual drivers 1003a are classified into multiple groups of individual drivers 1003g, each consisting of four consecutive drivers, grayscale voltages of mutually opposite polarities are output from two arbitrary individual drivers 1003a that are adjacent to each other in each group of individual drivers 1003g. And the polarity of the grayscale voltage output from an s^{th} individual driver 1003a (where s is naturally an integer that falls within the range of one to four) in an odd-numbered group of individual drivers 1003g is opposite to that of the grayscale voltage output from the s^{th} individual driver 1003a in an even-numbered group of individual drivers 1003g. Consequently, in each group 1003g of individual drivers, the grayscale voltages output from the individual drivers 1003a have either polarities that invert in the row direction or the same polarity back to back at the boundary between multiple groups 1003g of individual drivers.

In the liquid crystal display device 1000 with such an arrangement, grayscale voltages of mutually opposite polarities are applied to the respective pixel electrodes of two pixels that are adjacent to each other in the row direction in each picture element P, and grayscale voltages of mutually opposite polarities are applied to the respective pixel electrodes of two pixels that display the same color and that belong to two picture elements P that are adjacent to each other in the row direction. Consequently, the voltages applied to those pixels that are arranged in the row direction to display the same color do not have the same polarity, thus avoiding casting such horizontal shadows.

### CITATION LIST

### Patent Literature

Patent Document No. 1: PCT International Application Japanese National Phase Publication No. 2004-529396

Patent Document No. 2: Japanese Patent Application Laid-Open Publication No. 11-295717

Patent Document No. 3: PCT International Application Publication No. 2007/063620

### SUMMARY OF INVENTION

### Technical Problem

If the technique disclosed in Patent Document No. 3 is adopted, however, particular pixels will be interposed between two signal lines 1013 that apply grayscale voltages of the same polarity. In the arrangement shown in FIG. 21, blue pixels B are located between a signal line 1013 associated with their own pixel electrodes and a signal line 1013 associated with the pixel electrodes of their adjacent white pixels W, and the grayscale voltages supplied through these two signal lines 1013 have the same polarity. Consequently, those pixels located between the two signal lines 1013 that supply the voltages of the same polarity come to have display luminances that are no longer the original levels. As a result, the display quality will decline. The reason will be described below with reference to FIG. 22.

As shown in FIG. 22(a), when a display signal (i.e., a source signal) supplied to a signal line 1013 after a pixel has been charged changes, the potential at its pixel electrode (i.e., a drain voltage) also varies by way of the parasitic capacitance between the source and the drain (i.e., a source-drain capacitance Csd). In that case, the magnitude ΔV of the variation can be calculated by the following Equation (1) using the magnitude of variation (i.e., amplitude) Vspp of the source signal, the source-drain capacitance Csd and the pixel capacitance Cpix:

ΔV=Vspp·(Csd/Cpix) (1)

In general, the potential at the pixel electrode of a certain pixel is affected by not only a variation in voltage on the signal line 1013 that supplies a grayscale voltage to the pixel electrode of that pixel (and that will be sometimes referred to herein as “its own source”) but also by a variation in voltage on the signal line 1013 that supplies a grayscale voltage to the pixel electrode of a pixel that is adjacent to the former pixel in the row direction (and that will be sometimes referred to herein as “others' source”). For that reason, if the polarities of its own source signal and others' source signal are opposite to each other as shown in FIG. 22(b), the variation ΔV in potential at the pixel electrode is canceled.

In the conventional liquid crystal display device 1000, however, since its own source signal and others' source signal have the same polarity in each of the pixels that are located between two signal lines that supply voltages of the same polarity, ΔV is not canceled. As a result, the drain voltage decreases by ΔV and the effective voltage applied to the liquid crystal layer decreases, too. Consequently, the display luminance varies from the original level, and the image on the screen darkens and the display quality gets debased in the normally black mode. Such a decline in display quality is recognized as lines of display unevenness that run in the column direction (and that are called “vertical shadows”).

It is therefore an object of the present invention to improve the display quality of such a liquid crystal display device of which each picture element is defined by an even number of pixels.

### Solution to Problem

A liquid crystal display device according to the present invention has a plurality of pixels, which are arranged in columns and rows to form a matrix pattern, and includes: an active-matrix substrate that includes pixel electrodes that are provided for the respective pixels, switching elements that are electrically connected to the pixel electrodes, a plurality of scan lines that run in a row direction, and a plurality of signal lines that run in a column direction; a counter substrate that faces the active-matrix substrate; a liquid crystal layer that is interposed between the active-matrix substrate and the counter substrate; and a signal line driver that supplies a positive or negative grayscale voltage as a display signal to each of the signal lines. Those pixels include m kinds of (where m is an even number that is equal to or greater than four) pixels that display mutually different colors. Grayscale voltages of the same polarity are supplied to two of the signal lines, which are adjacent to each other with one of the m kinds of pixels interposed between the signal lines themselves. The active-matrix substrate further includes an additional signal line, which is arranged between the two signal lines so as to run in the column direction and which is supplied with a grayscale voltage, of which the polarity is opposite to that of the grayscale voltages supplied to the two signal lines.

In one preferred embodiment, the pixels are arranged so that the m kinds of pixels are repeatedly arranged in the same order in the row direction.

In one preferred embodiment, that one of the m kinds of pixels has a smaller aperture ratio than at least one of the other kinds of pixels.

In one preferred embodiment, the additional signal line is electrically connected to another one of the signal lines other than the two signal lines, and one of the m kinds of pixels, of which the pixel electrodes are supplied with a grayscale voltage by way of the signal line to which the additional signal line is connected, are smaller than at least one of the other kinds of pixels.

In one preferred embodiment, the pixels include red, green, blue and yellow pixels representing the colors red, green, blue and yellow, respectively.

In one preferred embodiment, the one kind of pixels that are located between the two signal lines represent one of the colors green and yellow.

In one preferred embodiment, the additional signal line is electrically connected to another one of the signal lines other than the two signal lines, and one of the m kinds of pixels, of which the pixel electrodes are supplied with a grayscale voltage by way of the signal line to which the additional signal line is connected, represent the other of the colors green and yellow.

In one preferred embodiment, the additional signal line is electrically connected to another one of the signal lines other than the two signal lines, and one of the m kinds of pixels, of which the pixel electrodes are supplied with a grayscale voltage by way of the signal line to which the additional signal line is connected, represent one of the colors green and yellow.

In one preferred embodiment, the active-matrix substrate further includes storage capacitor lines that run in the row direction, and redundant storage capacitor lines that run substantially parallel to, and are electrically connected to, the storage capacitor lines.

In one preferred embodiment, the additional signal line is not electrically connected to the switching elements.

In one preferred embodiment, grayscale voltages of opposite polarities are supplied to two of the signal lines that are adjacent to each other with another one of the m kinds of pixels, other than the at least one kind of pixels, interposed between themselves.

In one preferred embodiment, the liquid crystal display device of the present invention includes a plurality of picture elements, each of which is defined by m pixels that are arranged consecutively in the row direction. In each of those picture elements, grayscale voltages of opposite polarities are applied to the pixel electrodes of two adjacent pixels. In two arbitrary ones of those picture elements that are adjacent to each other in the row direction, grayscale voltages of mutually opposite polarities are applied to the pixel electrodes of pixels that display the same color.

In one preferred embodiment, the signal line driver includes a plurality of output terminals that are arranged in the row direction. The output terminals include multiple groups of output terminals, each said group including m output terminals that are arranged consecutively in the row direction. In each said group of output terminals, two adjacent ones of the output terminals output grayscale voltages of opposite polarities. In two arbitrary ones of the groups of output terminals that are adjacent to each other in the row direction, two output terminals at the same position output grayscale voltages of opposite polarities.

In one preferred embodiment, the signal line driver includes a plurality of output terminals that are arranged in the row direction. Two adjacent ones of the output terminals output grayscale voltages of opposite polarities. The liquid crystal display device has connection regions where each of the signal lines is connected to an associated one of the output terminals one to one. The connection regions include a sequential connection region where an i^{th} signal line (where i is a natural number) and an i^{th} output terminal are connected together and reverse connection regions where a j^{th} signal line (where j is a different natural number from i) and a (j+1)^{th} output terminal are connected together and where a (j+1)^{th} signal line and a j^{th} output terminal are connected together.

A display defect repairing method according to the present invention is a method for repairing a display defect of a liquid crystal display device that has a configuration in which the storage capacitor lines and the redundant storage capacitor lines are provided for the active-matrix substrate. The method includes the steps of: inspecting the signal lines to spot a signal line that is either short-circuited with any of the scan lines or disconnected; and forming a bypass route using the additional signal line and the redundant storage capacitor line so that a display signal bypasses the short-circuited or disconnected part of the signal line that has been spotted.

In one preferred embodiment, the step of forming the bypass route includes the steps of: electrically connecting the redundant storage capacitor line that is located upstream with respect to the short-circuited or disconnected part to the signal line that has been spotted; electrically connecting the upstream redundant storage capacitor line to the additional signal line; electrically connecting another redundant storage capacitor line that is located downstream with respect to the short-circuited or disconnected part to the signal line that has been spotted; electrically connecting the downstream redundant storage capacitor line to the additional signal line; and cutting off the upstream and downstream redundant storage capacitor lines and the additional signal line at their predetermined points.

### ADVANTAGEOUS EFFECTS OF INVENTION

The present invention improves the display quality of a liquid crystal display device, of which each picture element is defined by an even number of pixels.

### BRIEF DESCRIPTION OF DRAWINGS

FIG. 1 illustrates a liquid crystal display device 100 as a preferred embodiment of the present invention.

FIG. 2 is a plan view schematically illustrating a region of the liquid crystal display device 100 according to a preferred embodiment of the present invention that is allocated to eight pixels arranged in eight columns and one row (i.e., two picture elements P that are adjacent to each other in the row direction).

FIG. 3 is a cross-sectional view schematically illustrating the liquid crystal display device 100 according to a preferred embodiment of the present invention as viewed on the plane 3A-3A′ shown in FIG. 2.

FIG. 4 schematically illustrates a liquid crystal display device 100 as a preferred embodiment of the present invention.

FIG. 5 is a cross-sectional view schematically illustrating the liquid crystal display device 100 according to a preferred embodiment of the present invention as viewed on the plane 5A-5A′ shown in FIG. 2.

FIG. 6 is a plan view schematically illustrating a region of the liquid crystal display device 100 according to a preferred embodiment of the present invention that is allocated to eight pixels arranged in eight columns and one row (i.e., two picture elements P that are adjacent to each other in the row direction).

FIG. 7 is a plan view schematically illustrating a region of a liquid crystal display device 200 as a preferred embodiment of the present invention that is allocated to eight pixels arranged in eight columns and one row (i.e., two picture elements P that are adjacent to each other in the row direction).

FIG. 8 schematically illustrates the liquid crystal display device 200 according to a preferred embodiment of the present invention.

FIG. 9 is a plan view schematically illustrating a region of a liquid crystal display device 300 as a preferred embodiment of the present invention that is allocated to eight pixels arranged in eight columns and one row (i.e., two picture elements P that are adjacent to each other in the row direction).

FIG. 10 illustrates how to repair a signal line 13 that has been disconnected in the liquid crystal display device 300 according to a preferred embodiment of the present invention.

FIG. 11 illustrates how to repair the signal line 13 that has been disconnected in the liquid crystal display device 300 according to a preferred embodiment of the present invention.

FIG. 12 illustrates another exemplary arrangement of pixels in the LCD panel 1.

FIG. 13 illustrates still another exemplary arrangement of pixels in the LCD panel 1.

FIG. 14 illustrates an alternative arrangement that is designed to carry out an inversion drive that can avoid casting horizontal shadows.

FIG. 15 schematically illustrates a conventional liquid crystal display device 800.

FIG. 16 schematically illustrates a conventional liquid crystal display device 900.

FIG. 17 shows the polarities of voltages applied to respective pixels when a dot inversion drive operation is carried out on a three-primary-color liquid crystal display device.

FIG. 18 shows the polarities of voltages applied to respective pixels when a dot inversion drive operation is carried out on a conventional liquid crystal display device 800.

FIG. 19 shows the polarities of voltages applied to respective pixels when a dot inversion drive operation is carried out on a conventional liquid crystal display device 900.

FIGS. 20(a) to 20(d) show how horizontal shadows are cast.

FIG. 21 schematically illustrates a conventional liquid crystal display device 1000.

FIGS. 22(a) and 22(b) show why the display quality is debased in a conventional liquid crystal display device 1000.

### DESCRIPTION OF EMBODIMENTS

Hereinafter, preferred embodiments of the present invention will be described with reference to the accompanying drawings. It should be noted, however, that the present invention is in no way limited to the preferred embodiments to be described below.

### Embodiment 1

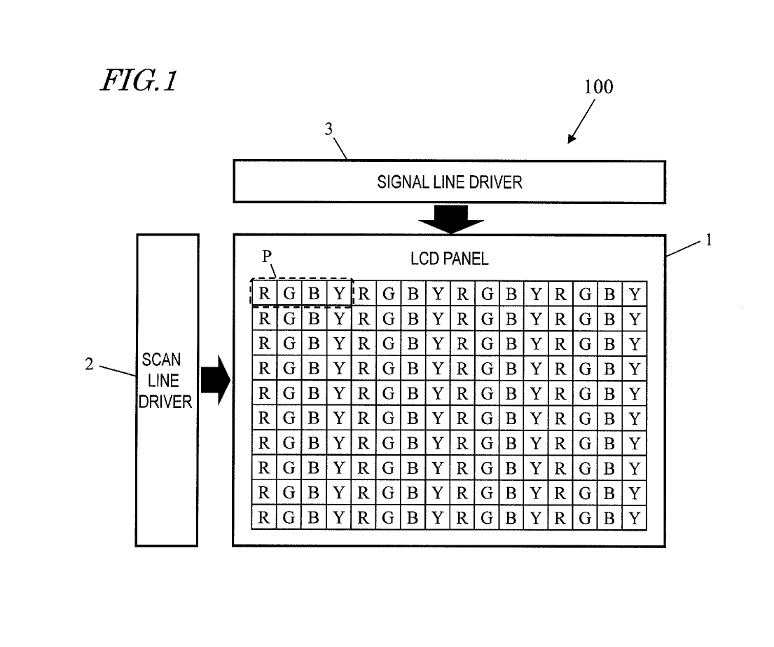

FIG. 1 illustrates a liquid crystal display device 100 as a first specific preferred embodiment of the present invention. As shown in FIG. 1, the liquid crystal display device 100 includes an LCD panel 1 with a plurality of pixels that are arranged in columns and rows to form a matrix pattern, and a scan line driver (or gate driver) 2 and a signal line driver (or source driver) 3 that supply drive signals to the LCD panel 1.

The pixels of the LCD panel 1 include red, green, blue, and yellow pixels R, G, B and Y representing the colors red, green, blue, and yellow, respectively. That is to say, the pixels include four kinds of pixels that represent mutually different colors.

Those pixels are arranged so that the four kinds of pixels are repeatedly arranged in the same order in the row direction. Specifically, in the example illustrated in FIG. 1, those pixels are arranged recursively in the order of red, green and blue and yellow pixels R, G, B and Y from the left to the right. One picture element P, which is the minimum unit to conduct a display operation in colors, is formed by a set of four pixels that are arranged consecutively in the row direction (i.e., the red, green, blue, and yellow pixels R, G, B and Y).

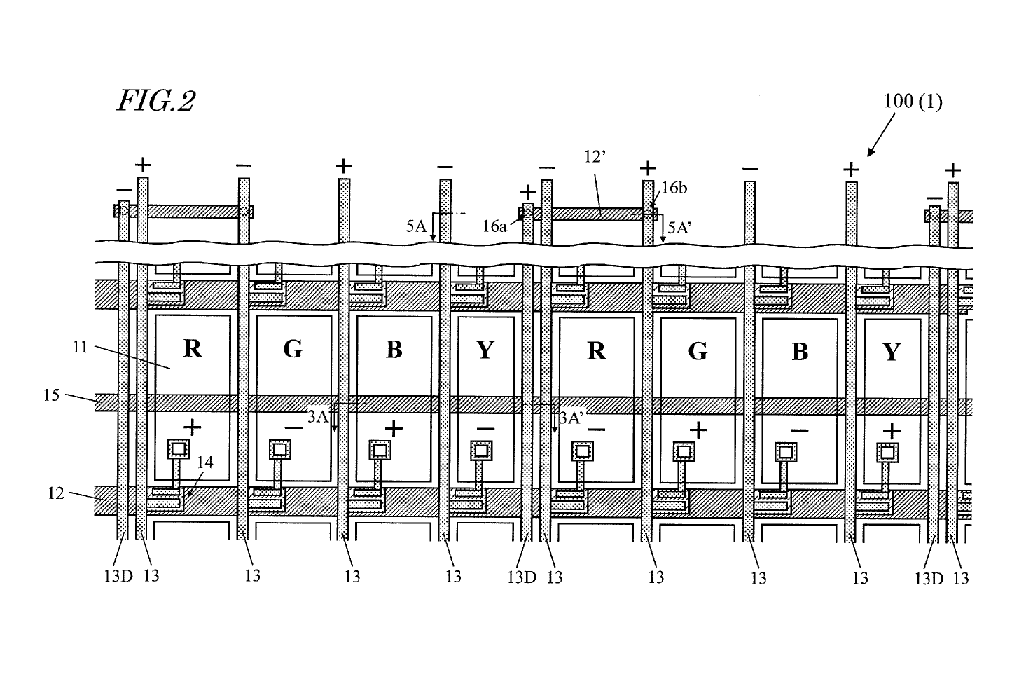

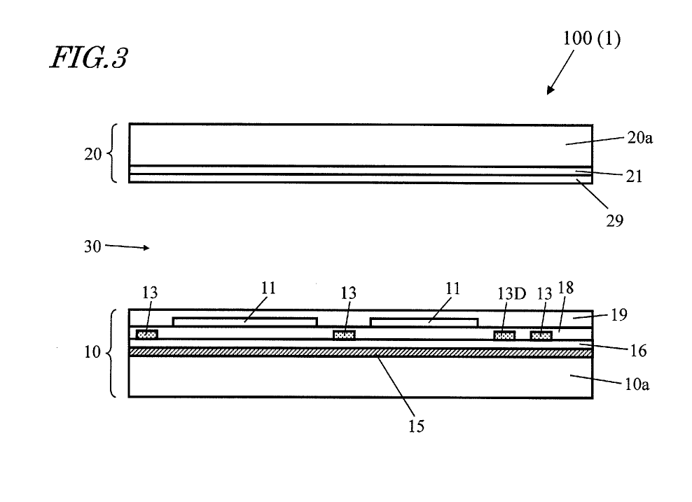

FIGS. 2 and 3 illustrate a specific structure for the LCD panel 1 of the liquid crystal display device 100. Specifically, FIG. 2 is a plan view illustrating a region of the LCD panel 1 that is allocated to eight pixels arranged in eight columns and one row (i.e., two picture elements P that are adjacent to each other in the column direction). FIG. 3 illustrates a portion of the LCD panel 1 corresponding to two pixels that are adjacent to each other in the row direction and is a cross-sectional view as viewed on the plane 3A-3A′ shown in FIG. 2.

The LCD panel 1 includes an active-matrix substrate 10, a counter substrate 20 that faces the active-matrix substrate 10, and a liquid crystal layer 30 that is interposed between the active-matrix substrate 10 and the counter substrate 20.

The active-matrix substrate 10 includes pixel electrodes 11, each of which is provided for an associated one of the pixels, thin-film transistors (TFTs) 14 that are electrically connected to the pixel electrodes 11, a plurality of scan lines 12 that run in the row direction, and a plurality of signal lines 13 that run in the column direction. Each TFT 14 functioning as a switching element is supplied with not only a scan signal from its associated scan line 12 but also a display signal from its associated signal line 13.

The scan lines 12 are arranged on a transparent substrate (e.g., a glass substrate) 10a with electrically insulating properties. On the transparent substrate 10a, also arranged is a storage capacitor line 15 that runs in the row direction (i.e., substantially parallel to the scan lines 12). In the structure illustrated in FIG. 2, the storage capacitor line 15 and the scan lines 12 are made of the same conductor film. The storage capacitor line 15 is supplied with a storage capacitor counter voltage (CS voltage).

A gate insulating film 16 is arranged to cover the scan lines 12 and the storage capacitor lines 15. On the gate insulating film 16, arranged are the signal lines 13. An interlayer insulating film 18 is arranged to cover the signal lines 13. The pixel electrodes 11 are located on the interlayer insulating film 18.

The counter substrate 20 includes a counter electrode 21, which faces the pixel electrodes 11 and which is arranged on a transparent substrate (such as a glass substrate) 20a with electrically insulating properties. Although not shown in any of the drawings, the counter substrate 20 typically further includes a color filter layer and an opaque layer (i.e., a black matrix). The color filter layer includes red, green, blue, and yellow color filters that transmit red, green, blue, and yellow rays, respectively, and that are associated with the red, green, blue, and yellow pixels R, G, B and Y, respectively. And the opaque layer is arranged between those color filters.

Alignment films 19 and 29 are arranged on the respective uppermost surfaces of the active-matrix substrate 10 and the counter substrate 20 to contact with the liquid crystal layer 30. As the alignment films 19 and 29, either horizontal alignment films or vertical alignment films are provided according to the mode of display to take.

The liquid crystal layer 30 includes liquid crystal molecules that have either positive or negative dielectric anisotropy depending on the mode of display, and a chiral agent as needed.

In the LCD panel 1 with such a structure, a liquid crystal capacitor C_{LC} is formed by the pixel electrode 11, the counter electrode 21 that faces the pixel electrode 11, and the liquid crystal layer 30 interposed between them. Also, a storage capacitor C_{CS} is formed by the pixel electrode 11, the storage capacitor line 15, and the gate insulating film 16 and interlayer insulating film 18 interposed between them. And a pixel capacitor Cpix is formed by the liquid crystal capacitor C_{LC} and the storage capacitor C_{CS} that is arranged in parallel to the liquid crystal capacitor C. It should be noted that the storage capacitor C_{CS} does not have to have this configuration. For example, the storage capacitor C_{CS} may also be formed by a storage capacitor electrode that is made of the same conductor film as the signal lines 13, the storage capacitor line 15, and the gate insulating film 16 interposed between them.

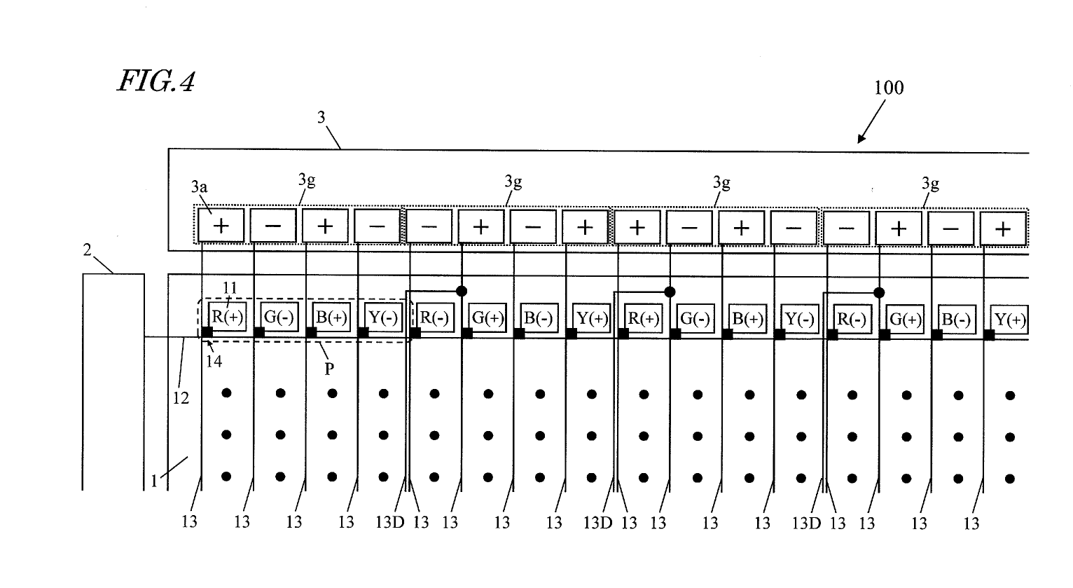

Hereinafter, the configuration of the liquid crystal display device 100 will be described in further detail with reference to FIGS. 4 and 5. FIG. 4 illustrates how the scan line driver 2, the signal line driver 3 and the LCD panel 1 are connected together and FIG. 5 is a cross-sectional view as viewed on the plane 5A-5A′ shown in FIG. 2.

The scan line driver 2 is connected to multiple scan lines 12 of the LCD panel 1 and supplies a scan signal to each of the multiple scan lines 12. On the other hand, the signal line driver 3 is connected to multiple signal lines 13 of the LCD panel 1 and supplies a display signal to each of the multiple signal lines 13. As shown in FIG. 4, the signal line driver 3 includes a plurality of output terminals 3a that are arranged in the row direction. Each of those output terminals 3a is connected one to one to an associated one of the signal lines 13. A positive or negative grayscale voltage is output through each of the output terminals 3a. That is why the signal line driver 3 supplies a positive or negative grayscale voltage as the display signal to each of the multiple signal lines 13.

The polarities of the grayscale voltages are determined by reference to the voltage applied to the counter electrode 21 (which will be referred to herein as a “counter voltage”). In FIGS. 2 and 4, the polarities of the grayscale voltages to be output through the output terminals 3a of the signal line driver 3 (and supplied to the signal lines 13) and those of the grayscale voltages applied to the pixel electrodes 11 through the signal lines 13 and the TFTs 14 in one vertical scanning period are indicated by “+” and “−”.

As shown in FIGS. 2 and 4, grayscale voltages of opposite polarities are applied to the respective pixel electrodes 11 of two pixels that are adjacent to each other in each picture element P. Likewise, although not shown, grayscale voltages of opposite polarities are also applied to the respective pixel electrodes 11 of two pixels that are adjacent to each other in the column direction.

In this manner, in this liquid crystal display device 100, the polarity of the grayscale voltage applied inverts one pixel after another not only in the column direction but also in the row direction (within each picture element P) as well. That is to say, the liquid crystal display device 100 performs an inversion drive that is similar to a dot inversion drive, and therefore, can achieve the same effect as what is produced by the dot inversion drive (e.g., can minimize the occurrence of flicker).

Furthermore, in the liquid crystal display device 100, grayscale voltages of mutually opposite polarities are applied to the respective pixel electrodes 11 of two pixels that display the same color and that belong to two picture elements P that are adjacent to each other in the row direction. Consequently, the voltages applied to those pixels that are arranged in the row direction to display the same color do not have the same polarity, thus avoiding casting horizontal shadows.

Such an inversion drive (i.e., an inversion drive that can avoid casting horizontal shadows) can be carried out if the signal line driver 3 has the configuration shown in FIG. 4, for example. In the arrangement shown in FIG. 4, the output terminals 3a of the signal line driver 3 include multiple groups 3g of output terminals, to each of which four output terminals 3a that are arranged consecutively in the row direction belong, just like the multiple picture elements P.

In each group 3g of output terminals, two adjacent output terminals 3a output grayscale voltages of opposite polarities. For example, in the leftmost group of output terminals 3g shown in FIG. 4, the leftmost and third leftmost output terminals 3a output positive grayscale voltages, while the second and fourth leftmost output terminals 3a output negative grayscale voltages.

Also, in two arbitrary ones of the groups 3g of output terminals that are adjacent to each other in the row direction, two output terminals 3a at the same position output grayscale voltages of opposite polarities. For example, in the leftmost group of output terminals 3g shown in FIG. 4, the leftmost and third leftmost output terminals 3a output positive grayscale voltages, while the second and fourth leftmost output terminals 3a output negative grayscale voltages as described above. On the other hand, in the adjacent group of output terminals 3g that is located on the right-hand side of the former group of output terminals, the leftmost and third leftmost output terminals 3a output negative grayscale voltages, while the second and fourth leftmost output terminals 3a output positive grayscale voltages.

If the signal line driver 3 has such a configuration, an inversion drive that can avoid casting horizontal shadows can also be carried out. However, if such an inversion drive is carried out, grayscale voltages of the same polarity are supplied to two signal lines 13 that are adjacent to each other with one of the four kinds of pixels interposed between them.

In the example illustrated in FIGS. 2 and 4, grayscale voltages of opposite polarities are supplied to each pair of signal lines 13 that are adjacent to each other with red, green or blue pixels R, G or B interposed between them. On the other hand, grayscale voltages of the same polarity are supplied to each pair of signal lines 13 that are adjacent to each other with yellow pixels Y interposed between them.

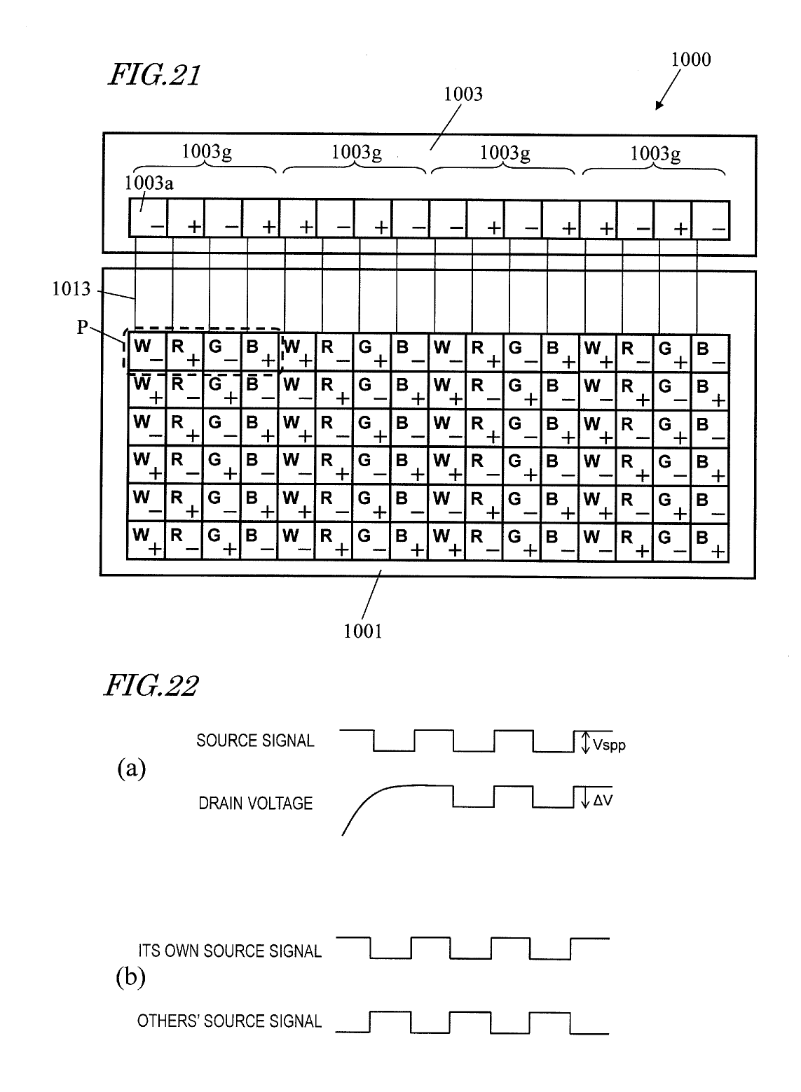

In the conventional liquid crystal display device 1000 shown in FIG. 21, those pixels located between the two signal lines 1013 that supply the voltages of the same polarity come to have display luminances that are no longer the original levels. As a result, the display quality will decline. However, the liquid crystal display device 100 of this preferred embodiment has the structure to be described below, and therefore, can minimize such a decline in display quality.

As shown in FIGS. 2 to 5, the active-matrix substrate 10 of this liquid crystal display device 100 includes additional signal lines (dummy signal lines) 13D, each of which is arranged between two signal lines 13 that are adjacent to each other with yellow pixels Y interposed between them (i.e., the signal line 13 provided for yellow pixels Y and the signal line 13 provided for red pixels R). The additional signal line 13D runs in the column direction (i.e., substantially parallel to the signal lines 13). More specifically, the additional signal line 13D is located between the pixel electrodes 11 of the yellow pixels Y and the signal line 13 provided for the red pixels R. That additional signal line 13D that is provided for the yellow pixels Y (i.e., the column of yellow pixels Y) is supplied with a grayscale voltage, of which the polarity is opposite to that of the grayscale voltages that are supplied to two signal lines that are adjacent to each other with the yellow pixels Y interposed between them.

To supply such grayscale voltages, the additional signal line 13 is electrically connected to a different signal line 13 from the signal line 13 that is provided for the yellow pixels Y (i.e., connected to the respective TFTs 14 of the yellow pixels Y) and from the signal line 13 that is provided for the red pixels R (i.e., connected to the respective TFTs 14 of the red pixels R). Specifically, the additional signal line 13 is electrically connected to the signal line 13 that is provided for the green pixels G (i.e., connected to the respective TFTs 14 of the green pixels G).

In this preferred embodiment, the active-matrix substrate 10 includes a connecting electrode 12′, which is made of the same conductor film as the scan signal lines 12 as shown in FIGS. 2 and 5. Through contact holes 16a and 16b that are cut through the gate insulating film 16, the connecting electrode 12′ is connected to the additional signal line 13D and the signal line 13 provided for green pixels 13. That is why the additional signal line 13D is electrically connected to the signal line 13 provided for the green pixels G via the connecting electrode 12′. Typically, the connecting electrode 12′ is arranged outside of the display area.

The additional signal line 13D is not electrically connected to the TFTs 14, and therefore, does not perform the signal line's (13) proper function of supplying a grayscale voltage to the pixel electrodes 11 via the TFTs 14.

As described above, in the liquid crystal display device 100 of this preferred embodiment, between two signal lines 13 that are adjacent to each other with yellow pixels Y interposed between them, arranged is an additional signal line (dummy signal line) 13D that is supplied with a grayscale voltage, of which the polarity is opposite to that of the grayscale voltages supplied to those two signal lines 13. That is why the potential at the respective pixel electrodes 11 of the yellow pixels Y is affected by one of the two signal lines 13 that are adjacent to each other with the yellow pixel Y interposed between them (more specifically, the signal line 13 provided for the yellow pixels Y) and by the additional signal line 13D (that is located closer to the respective pixel electrodes 11 of the yellow pixels Y than the signal line 13 provided for the red pixels R is). That is to say, the potential at the respective pixel electrodes 11 of the yellow pixels Y are affected by those two lines to which grayscale voltages of opposite polarities are supplied (i.e., the signal line 13 provided for the yellow pixels Y and the additional signal line 13D). That is why in not just the red, green and blue pixels R, G and B but also the yellow pixels Y, the variation ΔV (represented by Equation (1)) in drain voltage via the source-drain capacitance Csd after the pixels have been charged (i.e., the potential at the pixel electrodes 11) is canceled, and therefore, a shift from the original level of the display luminance can be reduced significantly. As a result, it is possible to avoid casting vertical shadows and the display quality improves.

In the preferred embodiment described above, as the yellow pixels Y are located between the signal lines 13 that supply voltages of the same polarity, the additional signal line 13D is provided for the column of yellow pixels Y. However, the present invention is in no way limited to that specific preferred embodiment. Alternatively, not the yellow pixels Y but pixels representing any other color (i.e., red, green or blue pixels R, G or B) may be located between the signal lines 13 that supply voltages of the same polarity. In that case, the additional signal line 13D may be provided for a column of those pixels.

Still, it is preferred that the column of pixels for which the additional signal line 13D is provided be either a column of green pixels G or a column of yellow pixels Y. In other words, it is preferred that either the green pixels G or the yellow pixels Y be located between signal lines 13 that supply voltages of the same polarity. The reason will be described below.

Since an area needs to be left for the additional signal line 13D, the column of pixels provided with the additional signal line 13D tends to have a lower aperture ratio than the other pixels (i.e., at least another kind of pixels). In the arrangement shown in FIG. 2, for example, as the signal lines 13 are arranged at a constant pitch, the pixel electrode 11 of the yellow pixels Y is smaller than those of the red, green and blue pixels R, G and B. That is why the aperture ratio of the yellow pixels Y is lower than those of the red, green and blue pixels R, G and B.

Generally speaking, green and yellow rays achieve a higher luminosity factor than red and blue rays. That is why even if those green and yellow pixels G and Y have a lower aperture ratio, the display operation will be affected to a lesser degree. In other words, it is easy to set their aperture ratio to be low. For that reason, the column of pixels to be provided with the additional signal line 13D is preferably either a column of green pixels G or a column of yellow pixels Y.

In addition, if a display operation is carried out in colors by using not just the colors red, green and blue but also the color yellow, the relative luminances of the colors red and blue (i.e., colors that achieve a relatively low luminosity factor) with respect to that of the color white will decrease so much compared to a situation where a display operation is carried out in only the colors red, green and blue that the lightness of the color red or blue to be displayed when a display operation is performed in a particular mode will decrease, too. For example, if the color red or blue is displayed by itself on a white or gray background (e.g., when a red or blue window is displayed), the color red or blue displayed will look blackish. In an arrangement in which the additional signal line 13D is provided for a column of green pixel G or a column of yellow pixels Y, the green or yellow pixels G or Y tend to have a lower aperture ratio than the other pixels as described above. In other words, the aperture ratios of the red and blue pixels R and B can be relatively high. Consequently, the arrangement in which the additional signal line 13D is provided for a column of green pixels G or a column of yellow pixels Y can also increase the lightness of the color red or blue, which is an another advantage achieved.

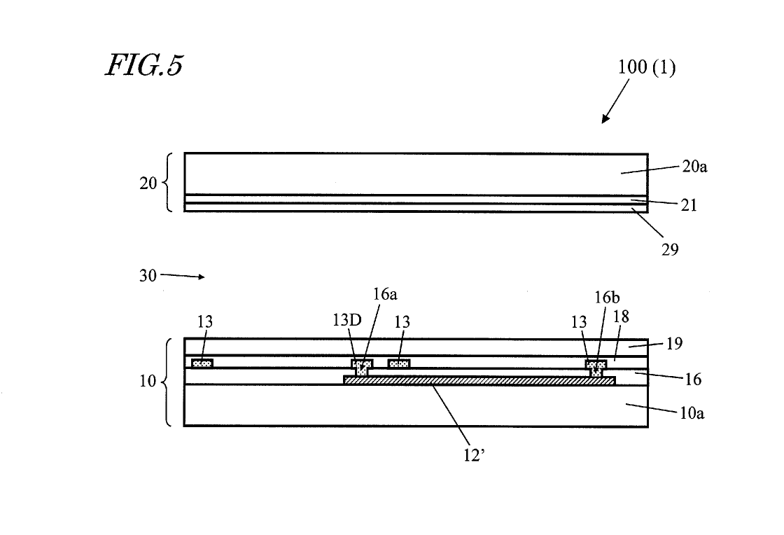

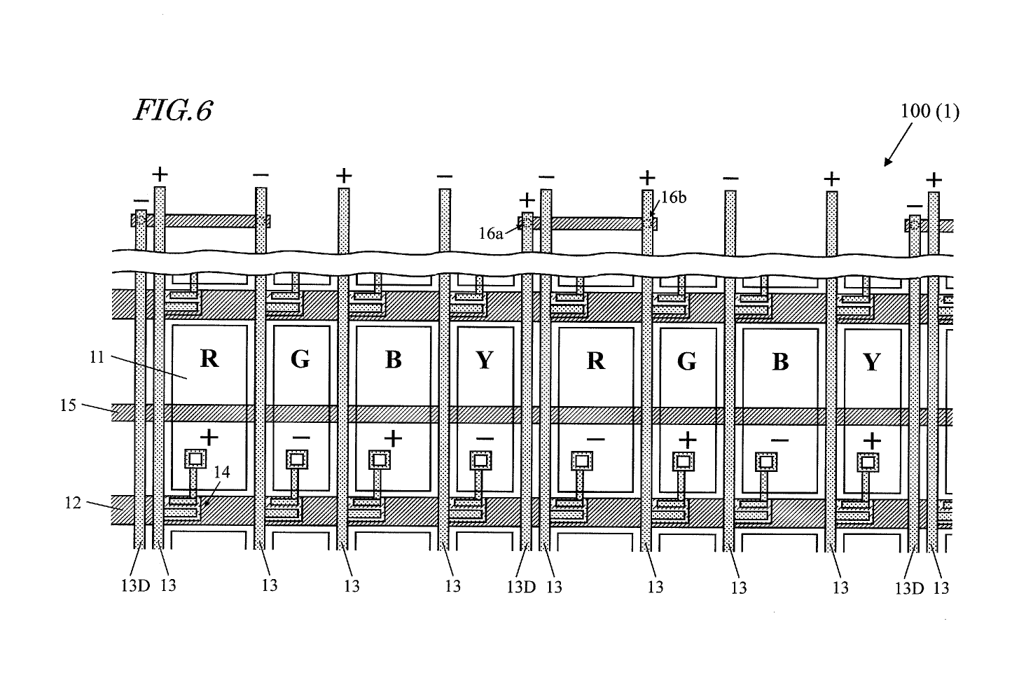

In the arrangement illustrated in FIG. 2, the three kinds of pixels (i.e., the red, green and blue pixels R, G and B) other than the yellow pixels Y, which form a column of pixels provided with the additional signal line 13D, are supposed to have substantially the same size. However, it is more preferred that the pixels, of which the pixel electrode is supplied with a grayscale voltage through the signal line 13 connected to the additional signal line 13D (i.e., the green pixels G in this example), be smaller than the other pixels (or at least another kind of pixels) as shown in FIG. 6. By adopting such an arrangement, an increase in the load imposed on the signal line 13 that is connected to the additional signal line 13D can be minimized.

As can be seen from the foregoing description, even if the sizes of the green and yellow pixels G and Y are reduced, the display operation will be hardly affected (i.e., those pixels can be easily designed to have a smaller size). For that reason, the pixels, of which the pixel electrode 11 is supplied with the grayscale voltage via the signal line 13 to which the additional signal line 13D is connected, are preferably green pixels G or yellow pixels Y. That is to say, it is preferred that the additional signal line 13D be connected to either the signal line 13 provided for the green pixels G or the signal line 13 provided for the yellow pixels Y.

As described above, the additional signal line 13D is preferably provided for either a column of green pixels G or a column of yellow pixels Y and preferably connected to either the signal line 13 provided for the green pixels G or the signal line 13 provided for the yellow pixels Y. For that reason, it is preferred that the pixels that are arranged between two signal lines 13 that are supplied with grayscale voltages of the same polarity be pixels representing the one of the colors green and yellow (i.e., either the green pixels G or the yellow pixels Y). And it is preferred that the pixels, of which the pixel electrode 11 is supplied with the grayscale voltage through the signal line 13 connected to the additional signal line 13D, be pixels representing the other color (i.e., either the yellow pixels Y or the green pixels G).

### Embodiment 2

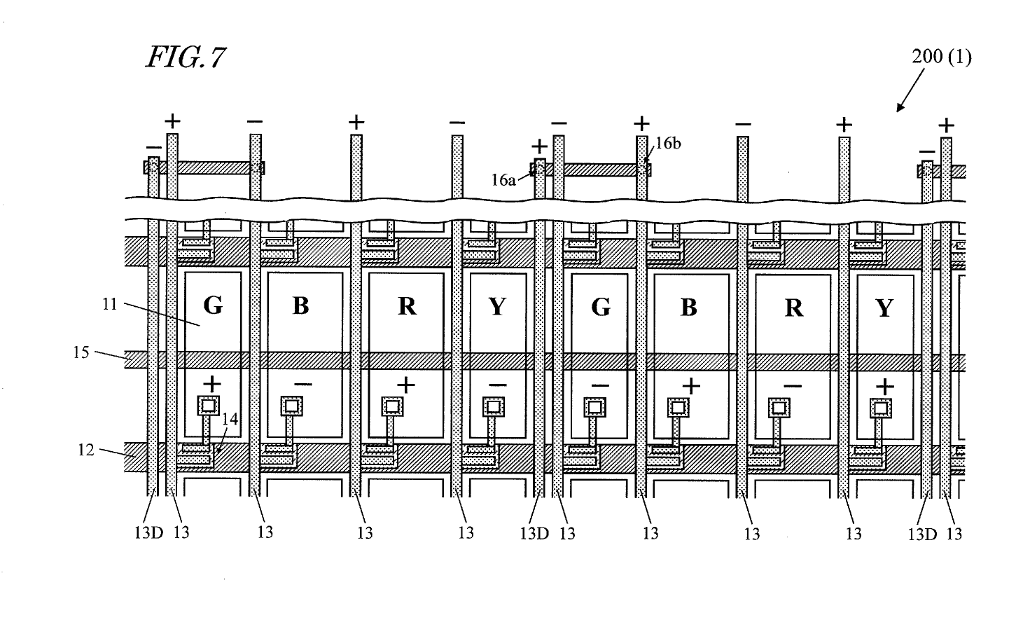

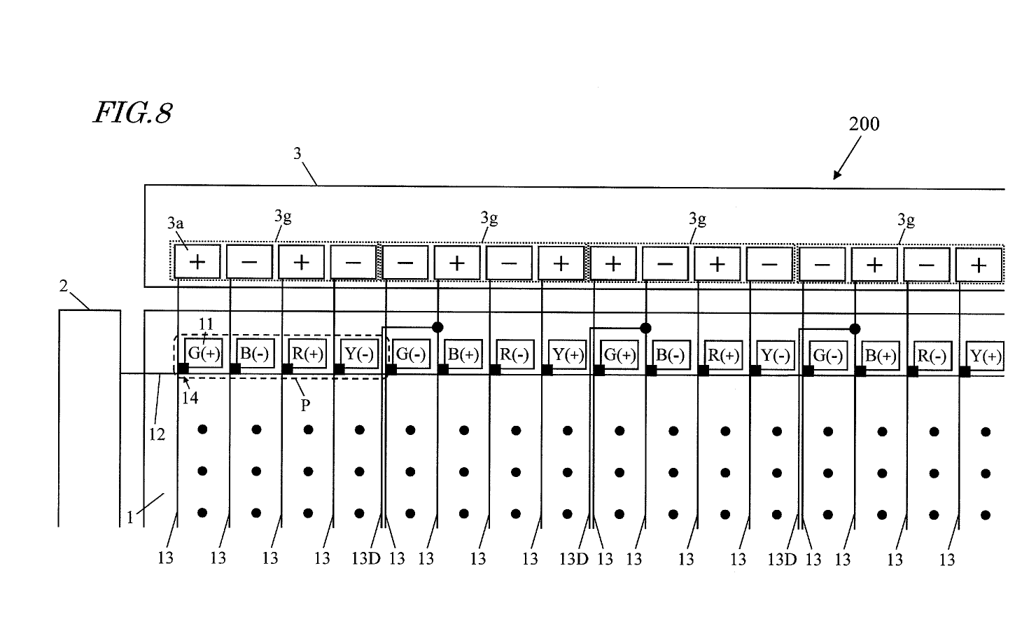

Hereinafter, a liquid crystal display device 200 as a second specific preferred embodiment of the present invention will be described with reference to FIGS. 7 and 8. The following description of this second preferred embodiment will be focused on differences between this liquid crystal display device 200 and its counterpart 100 of the first preferred embodiment described above.

In the liquid crystal display device 100 of the first preferred embodiment described above, pixels are arranged recursively in the order of red, green, blue and yellow pixels R, G, B and Y from the left to the right as shown in FIG. 1 and other drawings. On the other hand, in the liquid crystal display device 200 of this second preferred embodiment, pixels are arranged recursively in the order of green, blue, red and yellow pixels G, B, R and Y from the left to the right as shown in FIGS. 7 and 8.

In this liquid crystal display device 200, grayscale voltages of the same polarity are also supplied to two signal lines 13 that are adjacent to each other with the yellow pixels Y interposed between them. In the liquid crystal display device 200, however, on the right-hand side of the yellow pixels Y, arranged adjacently are green pixels G, not red pixels R, and therefore, the two signal lines 13 that are adjacent to each other with the yellow pixels Y interposed between them are the signal line 13 provided for the yellow pixels Y and the signal line 13 provided for the green pixels G. And between these two signal lines 13, arranged is an additional signal line 13D, which is electrically connected to the signal line 13 provided for the blue pixels B and which is supplied with a grayscale voltage of the opposite polarity to the voltages supplied to those two signal lines 13. As a result, the liquid crystal display device 200 of this preferred embodiment can also avoid casting vertical shadows.

### Embodiment 3

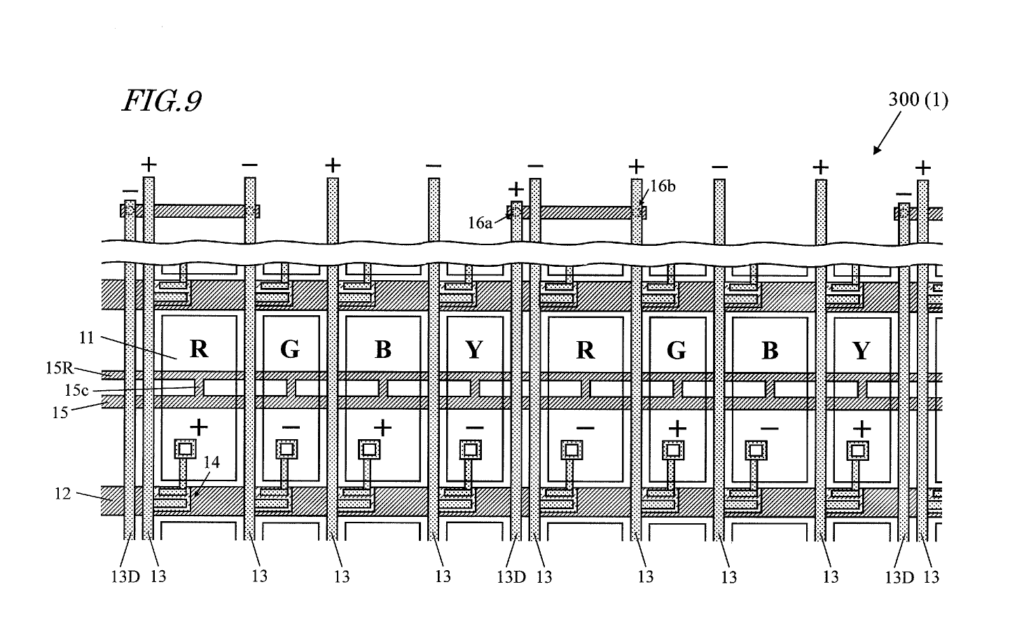

Hereinafter, a liquid crystal display device 300 as a third specific preferred embodiment of the present invention will be described with reference to FIG. 9. The following description of this third preferred embodiment will be focused on differences between this liquid crystal display device 300 and its counterpart 100 of the first preferred embodiment described above.

In this liquid crystal display device 300, grayscale voltages of the same polarity are also supplied to two signal lines 13 that are adjacent to each other with the yellow pixels Y interposed between them. Between these two signal lines 13, however, arranged is an additional signal line 13D to be supplied with a grayscale voltage of the opposite polarity to the ones supplied to those two signal lines 13. As a result, it is possible to avoid casting vertical shadows.

In addition, in the liquid crystal display device 300 of this preferred embodiment, further provided is a redundant storage capacitor line 15R, which runs substantially parallel to the storage capacitor line 15 (i.e., runs in the row direction) and which is electrically connected to the storage capacitor line 15 via a connecting portion 15c. In this preferred embodiment, the storage capacitor line 15, the redundant storage capacitor line 15R and the connecting portion 15c are all made of the same conductor film and are integrated together.

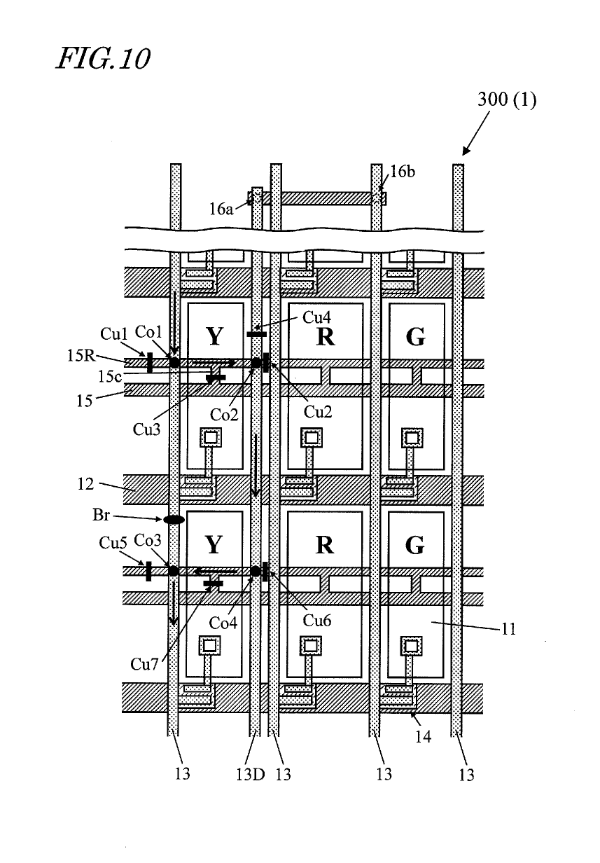

By providing such a redundant storage capacitor line 15R, a display defect to be caused due to either disconnection of a signal line 13 or a short-circuit between a signal line 13 and a scan line 12 can be repaired easily, and therefore, a decrease in yield can be minimized. Hereinafter, it will be described with reference to FIG. 10 exactly how to repair such a display defect using the redundant storage capacitor line 15R.

First of all, it is determined which of the multiple signal lines 13 is either short-circuited with any of the signal lines 12 or disconnected. For that purpose, the liquid crystal display device 300 may be perform a test display operation, thereby spotting a pixel with a display defect with the eyes (e.g., with a magnifying glass). As a result, a signal line 13 that supplies a display signal to such a pixel with a display defect is spotted as a signal line 13 with short-circuit or disconnection.

Next, as shown in FIG. 10, a bypass route is formed using the additional signal line 13D and the redundant storage capacitor line 15R so that a display signal bypasses the short-circuited or disconnected part of the defective signal line 13 that has been spotted.

FIG. 10 illustrates a situation where the signal line 13 provided for the yellow pixels Y is disconnected. In that case, first of all, the signal line 13 for the yellow pixels 13 and the redundant storage capacitor line 15R are electrically connected together (at a point of connection Co1) upstream with respect to the disconnected part Br (i.e., closer to the signal line driver 3 than the disconnected part Br is). This electrical connection may be made by irradiating with a laser beam, and melting and connecting together, the signal line 13 and the redundant storage capacitor line 15R. Electrical connection between two lines to be described later can also be made in the same way. Next, the redundant storage capacitor line 15R and the additional signal line 13D are electrically connected together at a point of connection Co2. Subsequently, the redundant storage capacitor line 15R is cut off at points of cutting Cu1 and Cu2 outside of the points of connection Co1 and Co2 and then the connecting portion 15c is also cut off at a point of cutting Cu3, thereby electrically isolating the portion of the redundant storage capacitor line 15R between the points of connection Co1 and Co2 from the storage capacitor line 15. The redundant storage capacitor line 15R and the connecting portion 15c may be cut off by irradiating with a laser beam, and melting and cutting, the redundant storage capacitor line 15R and the connecting portion 15c. Cutting of a line to be described later can also get done in the same way.

Next, the additional signal line 13D is cut off at a point of cutting Cu4 upstream with respect to the point of connection Co2. As a result, the portion of the additional signal line 13D that is located downstream with respect to the point of cutting Cu4 is electrically isolated from the signal line 13 provided for the green pixels G (i.e., from the signal line driver 3).

Subsequently, downstream with respect to the disconnected part Br (i.e., more distant from the signal line driver 3 than the disconnected part Br is), the signal line 13 provided for the yellow pixels Y and the redundant storage capacitor line 15R are electrically connected together at a point of connection Co3. Next, the redundant storage capacitor line 15R and the additional signal line 13D are electrically connected together at a point of connection Co4. Thereafter, the redundant storage capacitor line 15R is cut off at points of cutting Cu5 and Cu6, which are outside of the points of connection Co3 and Co4, and the connecting portion 15c is also cut off at a point of cutting Cu1, thereby electrically isolating the portion of the redundant storage capacitor line 15R between the points of connection Co3 and Co4 from the storage capacitor line 15.

By connecting and cutting off the lines as described above, the portion of the redundant storage capacitor line 15R that is located upstream with respect to the disconnected part Br (that runs from the point of connection Co1 through the point of connection Co2), the portion of the additional signal line 13D (that runs from the point of connection Co2 through the point of connection Co4), and the portion of the redundant storage capacitor line 15R that is located downstream with respect to the disconnected part Br (that runs from the point of connection Co3 through the point of connection Co4) together function as a bypass route that transmits a display signal with the disconnected part Br bypassed. That is why the portion of the signal line 13 for the yellow pixels Y that is located downstream with respect to the disconnected part Br can supply the grayscale voltage as originally designed.

In this example, a signal line 13 is supposed to be disconnected. Even if a signal line 13 and a scan line 12 are short-circuited together, a display defect can also be repaired by forming a bypass route in the same way.

As described above, the step of forming the bypass route includes the steps of: electrically connecting a redundant storage capacitor line 15R that is located upstream with respect to a short-circuited or disconnected part to a signal line 13 in question; electrically connecting the upstream redundant storage capacitor line 15R to an additional signal line 13D; electrically connecting a redundant storage capacitor line 15R that is located downstream with respect to the short-circuited or disconnected part to the signal line 13R in question; electrically connecting the downstream redundant storage capacitor line 15R to the additional signal line 13D; and cutting off the upstream and downstream redundant storage capacitor lines 15R and the additional signal line 13D at their predetermined points.

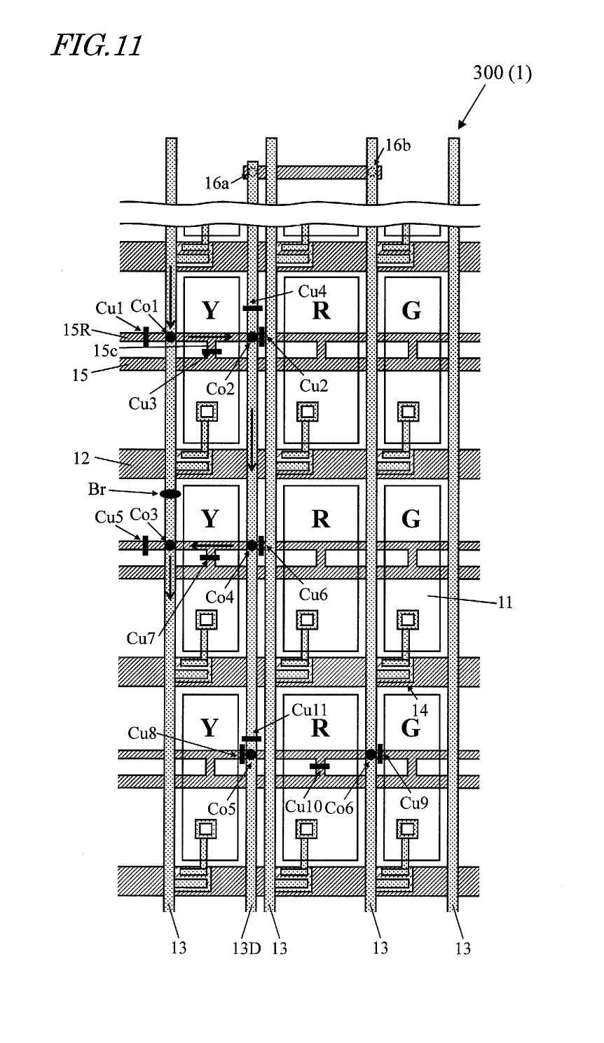

It should be noted that another portion of the additional signal line 13D that is located downstream with respect to its portion functioning a bypass route would be electrically connected to the signal line 13 provided for the yellow pixels Y as it were, and therefore, is preferably connected again to the signal line 13 provided for the green pixels G as will be described later with reference to FIG. 11.

As shown in FIG. 11, first of all, another redundant storage capacitor line 15R, which is located downstream with respect to the redundant storage capacitor line 15R that forms part of the bypass route, is electrically connected to the additional signal line 13D at a point of connection Co5 and then to the signal line 13 provided for the green pixels G at a point of connection Co6. Next, the redundant storage capacitor line 15R is cut off at points of cutting Cu8 and Cu9 outside of the points of connection Co5 and Co6 and the connecting portion 15c is also cut off at a point of cutting Cu10, thereby electrically isolating the portion of the redundant storage capacitor line 15R that runs from the point of connection Co5 through the point of connection Co6 from the storage capacitor line 15. Thereafter, the additional signal line 13D is cut off at a point of cutting Cu11 upstream with respect to the point of connection Co5 (more specifically, between the points of connection Co4 and Co5). In this manner, another portion of the additional signal line 13D that is located downstream with respect to its portion that forms part of the bypass route can be electrically connected to the signal line 13 provided for the green pixels 13 by way of the portion of the redundant storage capacitor line 15R that runs from the point of connection Co5 through the point of connection Co6. As a result, the effect of avoiding casting vertical shadows can be maintained.

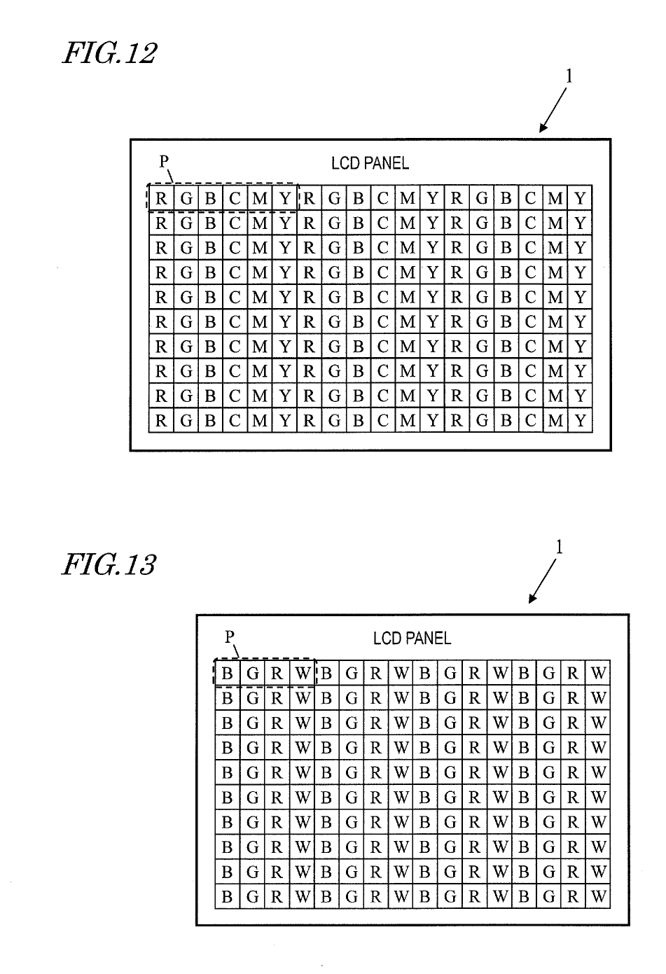

In the first through third preferred embodiments of the present invention described above, four kinds of pixels are supposed to be arranged side by side in the row direction by way of illustrative example. However, the present invention is in no way limited to those specific preferred embodiments. Rather the present invention is broadly applicable for use in a liquid crystal display device that includes m kinds of pixels (where m is an even number that is equal to or greater than four). For example, six kinds of pixels may be included as in the LCD panel 1 shown in FIG. 12. In the arrangement shown in FIG. 12, the pixels include not only the red, green, blue, and yellow pixels R, G, B, and Y but also cyan pixel C representing cyan and magenta pixel M representing magenta as well, and each picture element P is defined by six pixels that are arranged consecutively in the row direction.

As for the respective kinds (i.e., the combination) of pixels that define a single picture element P, the combinations described above are just examples, too. For example, if each picture element P is defined by four kinds of pixels, each picture element P may be defined by either red, green, blue and cyan pixels R, G, B and C or red, green, blue and magenta pixels R, G, B and M. Alternatively, each picture element P may also be defined by red, green, blue and white pixels R, G, B and W as shown in FIG. 13. If the arrangement shown in FIG. 13 is adopted, a colorless and transparent color filter (i.e., a color filter that transmits white light) is arranged in a region of the color filter layer of the counter substrate 20 that is allocated to the white pixel W. With the arrangement shown in FIG. 13 adopted, the color reproduction range cannot be broadened because the primary color added is the color white, but the overall display luminance of a single picture element P can be increased.

Also, in the arrangements exemplarily shown in FIGS. 1, 12 and 13, m different kinds of pixels are arranged in one row and m columns within each picture element P, and the color filters have a so-called “striped arrangement”. However, this is only an example of the present invention, too. Rather, those pixels may be arranged so that the m kinds of pixels are arranged in the row direction. That is to say, the pixels may be arranged in matrix in each picture element P. For example, in each picture element P, the pixels may be arranged in two rows and m columns. In that case, a single picture element P is defined by 2m pixels.

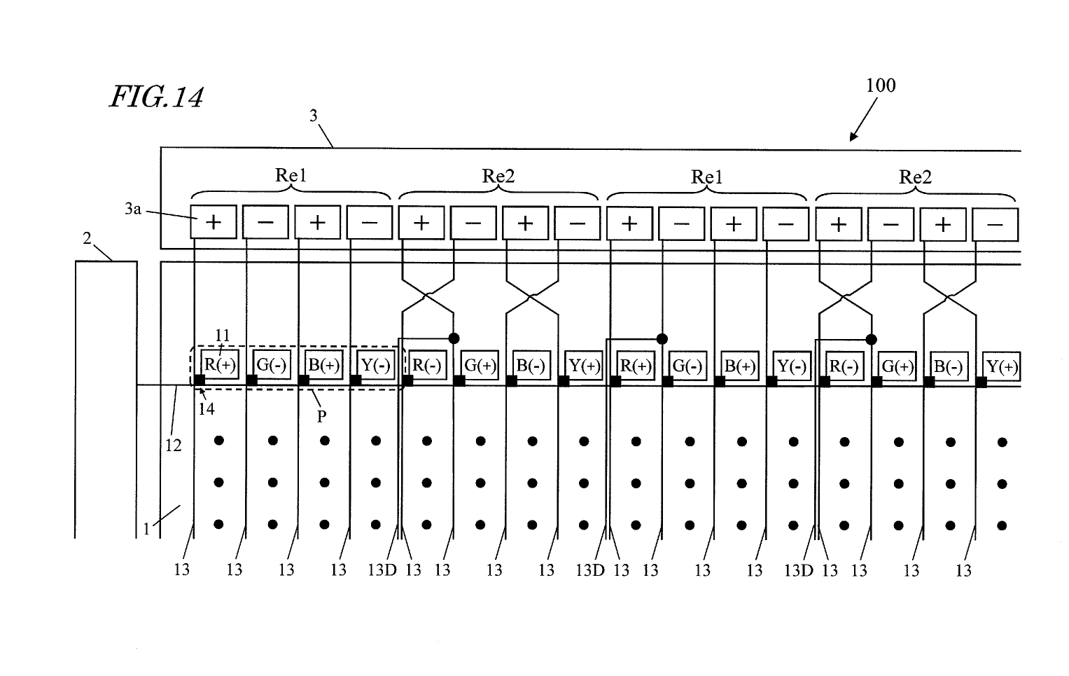

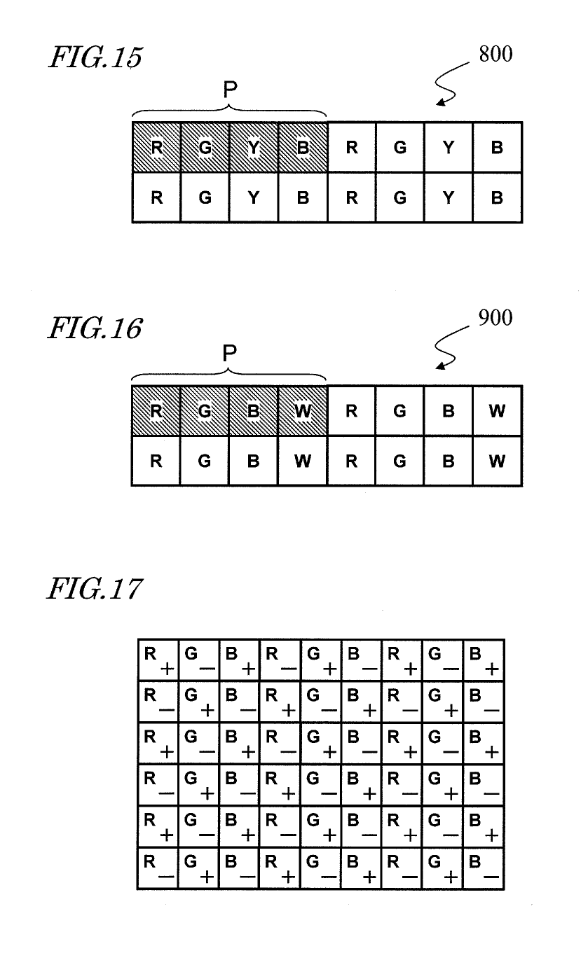

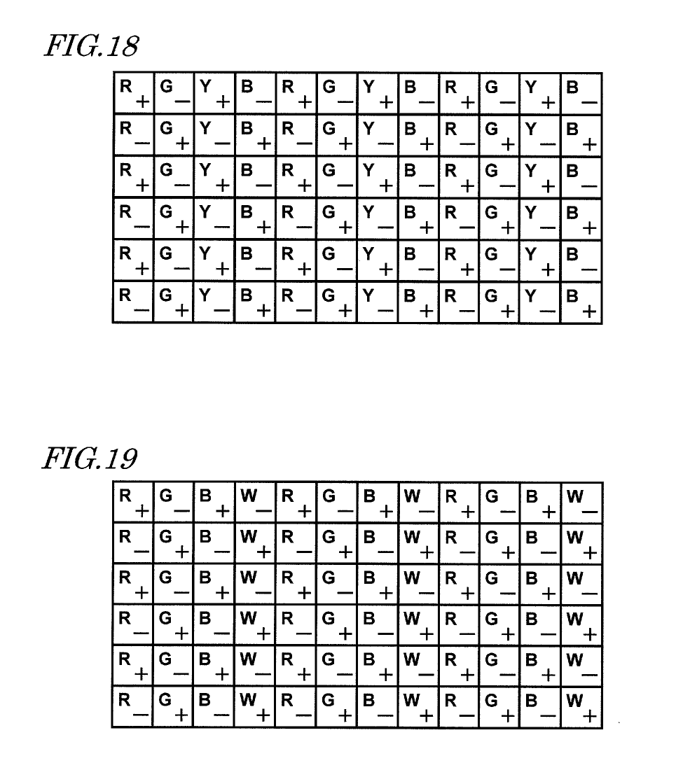

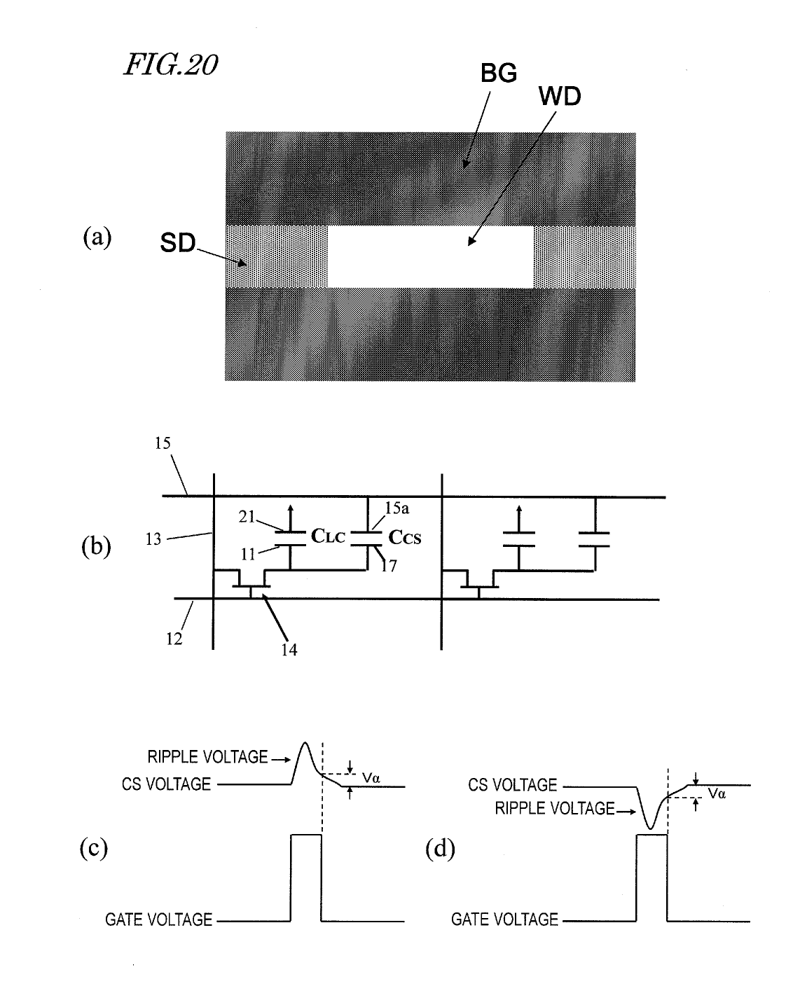

Furthermore, the arrangement that carries out the inversion drive to avoid casting horizontal shadows does not have to be the one shown in FIG. 4 or 8. Alternatively, the arrangement shown in FIG. 14 may be adopted as well.

In the signal line driver 3 shown in FIG. 14, two adjacent ones of the output terminals 3a output grayscale voltages of mutually opposite polarities. That is to say, the polarity of the grayscale voltage output from the signal line driver 3 always inverts every pixel in the row direction.

If regions where those output terminals 3a are connected to the signal lines 13 are referred to as “connection regions”, those connection regions include two kinds of regions Re1 and Re2 in the arrangement shown in FIG. 14. Hereinafter, those regions Re1 and Re2 will be described in detail. In the following description, those signal lines 13 will be counted from the left to the right in FIG. 14 and will be referred to herein as “first, second, third signal lines 13” and so on. In the same way, those output terminals 3a will also be counted from the left to the right in FIG. 14 and will also be referred to herein as “first, second, third output terminals 3a” and so on.

As shown in FIG. 14, in each of the regions Re1, an i^{th} signal line 13 (where i is a natural number) and an i^{th} output terminal 3a are connected together. That is to say, the signal lines 13 and the output terminals 3a are connected together sequentially. That is why this kind of regions Re1 will be referred to herein as “sequential connection regions”. For example, in the sequential connection region Re1 shown on the left-hand side of FIG. 4, the first signal line 13 and the first output terminal 3a are connected together, so are the second signal line 13 and the second output terminal 3a, the third signal line 13 and the third output terminal 3a, and the fourth signal line 13 and the fourth output terminal 3a.

On the other hand, in each of the regions Re2, a j^{th} signal line 13 (where j is a different natural number from i) and a (j+1)^{th} output terminal 3a are connected together and a (j+1)^{th} signal line 13 and a j^{th} output terminal 3a are connected together. That is to say, the signal lines 13 and the output terminals 3a are not connected sequentially but in reverse order. That is why this kind of regions Re2 will be referred to herein as “reverse connection regions”. For example, in the reverse connection region Re2 shown on the left-hand side of FIG. 4, the fifth signal line 13 and the sixth output terminal 3a are connected together, so are the sixth signal line 13 and the fifth output terminal 3a, the seventh signal line 13 and the eighth output terminal 3a, and the eighth signal line 13 and the seventh output terminal 3a.

Even if there are such sequential connection regions Re1 and reverse connection regions Re2 in the same mixture as described above, an inversion drive can also be carried out with the horizontal shadows eliminated.

### INDUSTRIAL APPLICABILITY

The present invention improves the display quality of a liquid crystal display device, of which each picture element is defined by an even number of pixels, and can be used effectively in a multi-primary-color liquid crystal display device.

### REFERENCE SIGNS LIST

1 LCD panel
2 scan line driver (gate driver)
3 signal line driver (source driver)
3a output terminal
10 active-matrix substrate
10a, 20a transparent substrate
11 pixel electrode
12 scan line
12′ connecting electrode
13 signal line
13D additional signal line (dummy signal line)
14 thin-film transistor (TFT)
15 storage capacitor line
15R redundant storage capacitor line
15c connecting portion
16 gate insulating film
16a, 16b contact hole
18 interlayer insulating film
19, 29 alignment film
20 counter substrate
21 counter electrode
30 liquid crystal layer
100, 200, 300 liquid crystal display device
P picture element
R red pixel
G green pixel
B blue pixel
Y yellow pixel
C cyan pixel
M magenta pixel
W white pixel
Br disconnected part
Cu1 to Cu11 cut portions of lines
Co1 to Co6 connected portions of lines

1. A liquid crystal display device having a plurality of pixels, which are arranged in columns and rows to form a matrix pattern, the device comprising:
an active-matrix substrate that includes pixel electrodes that are provided for the respective pixels, switching elements that are electrically connected to the pixel electrodes, a plurality of scan lines that run in a row direction, and a plurality of signal lines that run in a column direction;
a counter substrate that faces the active-matrix substrate;
a liquid crystal layer that is interposed between the active-matrix substrate and the counter substrate; and
a signal line driver that supplies a positive or negative grayscale voltage as a display signal to each of the signal lines,
wherein those pixels include m kinds of (where m is an even number that is equal to or greater than four) pixels that display mutually different colors, and
wherein grayscale voltages of the same polarity are supplied to two of the signal lines, which are adjacent to each other with one of the m kinds of pixels interposed between the signal lines themselves, and
wherein the active-matrix substrate further includes an additional signal line, which is arranged between the two signal lines so as to run in the column direction and which is supplied with a grayscale voltage, of which the polarity is opposite to that of the grayscale voltages supplied to the two signal lines.

2. The liquid crystal display device of claim 1, wherein that one of the m kinds of pixels has a smaller aperture ratio than at least one of the other kinds of pixels.

3. The liquid crystal display device of claim 1, wherein the additional signal line is electrically connected to another one of the signal lines other than the two signal lines, and
wherein one of the m kinds of pixels, of which the pixel electrodes are supplied with a grayscale voltage by way of the signal line to which the additional signal line is connected, are smaller than at least one of the other kinds of pixels.

4. The liquid crystal display device of claim 1, wherein the pixels include red, green, blue and yellow pixels representing the colors red, green, blue and yellow, respectively.

5. The liquid crystal display device of claim 4, wherein the one kind of pixels that are located between the two signal lines represent one of the colors green and yellow.

6. The liquid crystal display device of claim 5, wherein the additional signal line is electrically connected to another one of the signal lines other than the two signal lines, and
wherein one of the m kinds of pixels, of which the pixel electrodes are supplied with a grayscale voltage by way of the signal line to which the additional signal line is connected, represent the other of the colors green and yellow.

7. The liquid crystal display device of claim 4, wherein the additional signal line is electrically connected to another one of the signal lines other than the two signal lines, and
wherein one of the m kinds of pixels, of which the pixel electrodes are supplied with a grayscale voltage by way of the signal line to which the additional signal line is connected, represent one of the colors green and yellow.

8. The liquid crystal display device of claim 1, wherein the active-matrix substrate further includes storage capacitor lines that run in the row direction, and redundant storage capacitor lines that run substantially parallel to, and are electrically connected to, the storage capacitor lines.

9. The liquid crystal display device of claim 1, wherein the additional signal line is not electrically connected to the switching elements.

10. The liquid crystal display device of claim 1, wherein grayscale voltages of opposite polarities are supplied to two of the signal lines that are adjacent to each other with another one of the m kinds of pixels, other than the at least one kind of pixels, interposed between themselves.

11. The liquid crystal display device of claim 1, comprising a plurality of picture elements, each of which is defined by m pixels that are arranged consecutively in the row direction,
wherein in each of those picture elements, grayscale voltages of opposite polarities are applied to the pixel electrodes of two adjacent pixels, and
wherein in two arbitrary ones of those picture elements that are adjacent to each other in the row direction, grayscale voltages of mutually opposite polarities are applied to the pixel electrodes of pixels that display the same color.

12. The liquid crystal display device of claim 1, wherein the signal line driver includes a plurality of output terminals that are arranged in the row direction, and
wherein the output terminals include multiple groups of output terminals, each said group including m output terminals that are arranged consecutively in the row direction, and
wherein in each said group of output terminals, two adjacent ones of the output terminals output grayscale voltages of opposite polarities, and
wherein in two arbitrary ones of the groups of output terminals that are adjacent to each other in the row direction, two output terminals at the same position output grayscale voltages of opposite polarities.

13. The liquid crystal display device of claim 1, wherein the signal line driver includes a plurality of output terminals that are arranged in the row direction, and
wherein two adjacent ones of the output terminals output grayscale voltages of opposite polarities, and
wherein the liquid crystal display device has connection regions where each of the signal lines is connected to an associated one of the output terminals one to one, and
wherein the connection regions include a sequential connection region where an ith signal line (where i is a natural number) and an ith output terminal are connected together and reverse connection regions where a jth signal line (where j is a different natural number from i) and a (j+1)th output terminal are connected together and where a (j+1)th signal line and a jth output terminal are connected together.

14. A method for repairing a display defect of the liquid crystal display device of claim 8, the method comprising the steps of:
inspecting the signal lines to spot a signal line that is either short-circuited with any of the scan lines or disconnected; and
forming a bypass route using the additional signal line and the redundant storage capacitor line so that a display signal bypasses the short-circuited or disconnected part of the signal line that has been spotted.

15. The method of claim 14, wherein the step of forming the bypass route includes the steps of:
electrically connecting the redundant storage capacitor line that is located upstream with respect to the short-circuited or disconnected part to the signal line that has been spotted;
electrically connecting the upstream redundant storage capacitor line to the additional signal line;
electrically connecting another redundant storage capacitor line that is located downstream with respect to the short-circuited or disconnected part to the signal line that has been spotted;
electrically connecting the downstream redundant storage capacitor line to the additional signal line; and
cutting off the upstream and downstream redundant storage capacitor lines and the additional signal line at their predetermined points.
